(19) United States
(12) Patent Application Publication
(10) Pub. No.: US 2012/0207448 A1
(43) Pub. Date: Aug. 16, 2012

(54) Audio Device, Video Device and Computer Program

(75) Inventor: Norihiko Hama, Iwaki (JP)

(73) Assignee: Alpine Electronics, Inc., Tokyo (JP)

(21) Appl. No.: 13/348,029

(22) Filed: Jan. 11, 2012

(30) Foreign Application Priority Data
Feb. 14, 2011 (JP) 2011-028670

(51) Int. Cl. H04N 9/80; G06F 17/00

(52) U.S. Cl. 386/241; 700/94; 386/E09.011

(57) ABSTRACT

A portable audio player holds a current playback list in which audio files which are playback targets are registered. An audio device holds a creation condition of a current playback list specified by the audio device last in a state where the portable audio player was connected, and a title which was a last playback target, and, when the portable audio player is connected, if information about the current playback list can be acquired from the portable audio player, makes the portable audio player resume playing back the current playback list and, if information cannot be acquired, makes the portable audio player create the current playback list under the held condition and start playing back the held title.

### RELATED APPLICATIONS

The present application claims priority to Japanese Patent Application Number 2011-028670, filed Feb. 14, 2011, the entirety of which is hereby incorporated by reference.

### BACKGROUND

1. Field of the Invention

The present invention relates to a technique of controlling resume playback of a portable audio player (also referred to as “portable music player”) connected to an audio device, and which records audio data of songs in a built-in HDD or semiconductor memory and plays back and outputs recorded audio data.

2. Description of the Related Art

Portable audio players store audio data in audio files and play back songs. Portable audio players are known which have functions for creating a playback list in which songs of playback targets are registered, playing a playback list of songs registered in the playback list, and when the start of playback is commanded after playback of the playback list is stopped, performing resume playback of the playback list from a song which is played back when the playback of the playback list is stopped.

Further, portable audio players are known which have a function for creating and playing back a playback list in which songs satisfying a condition are registered, according to the condition of attributes of songs specified by a connected audio device, and a function for providing to the audio device information about the held playback list in response to a request from the audio device in a connected state with the audio device and performing the above resume playback in response to control by the audio device.

Further, a technique is known for resuming a playback state of a portable audio player connected with an audio device, from a state upon previous connection, which specifies the condition, makes the portable audio player create and play back a playback list, holds the condition used to create the playback list which is played back when the portable audio player is disconnected and information about a song which is played back, and when the portable audio player is reconnected, specifies the condition for which information is held and makes the portable audio player recreate the playback list and start playing back the playback list created from songs for which information is held (Japanese Patent Application Laid-Open 2007-220212).

Some portable audio players transition to a state where information about a held playback list is not provided to a connected audio device when power is turned off and is turned on afterwards.

Further, in this case, it is not possible to control playback using information about the playback list in the audio device and present to the user a playback list or information about a song which is played back, and therefore it is not possible to perform resume playback with a portable audio player alone in a state where the portable audio player is connected to the audio device.

By contrast with this, if the audio device always recreates the above playback list to resume a playback state of the connected portable audio player, from a state upon previous connection, when a portable audio player alone was used and then is connected to the audio device, it is not possible to resume playing back a song which was played back last from a playback list which was played back last during a period in which the portable audio player alone was used. Hence, in a state where the portable audio player is connected to the audio device, it is not possible to perform the same resume playback as resume playback performed by the portable audio player alone.

By contrast with this, even in a state where the portable audio player is connected to the audio device, the user expects that resume playback can be performed similar to cases where the portable audio player alone is utilized.

It is therefore an object of the present invention to perform resume playback of a connected portable audio player, in an audio device with which a portable audio player is connected according to the same mode as resume playback performed by the portable audio player alone as much as possible.

### SUMMARY

To achieve the above task, an audio device which can store audio data of a song and a playback list in which audio data is registered, and which can be connected with a portable audio player which plays back audio data registered in the playback list, comprises: a playback list creating unit which makes the portable audio player connected with the audio device create the playback list in which audio data of a song matching a filter condition is registered, using a condition of an attribute of a song specified by a user as a filter condition; a filter condition holding unit which, when the portable audio player is connected, holds the filter condition used last by the playback list creating unit to create the playback list of the portable audio player; and a resume playback control unit which, when the portable audio player is connected, tries to acquire information about the playback list held by the portable audio player, from the portable audio player, and, when information about the playback list can be acquired, makes the portable audio player start playing back the playback list held in the portable audio player and, when information about the playback list cannot be acquired, makes the portable audio player connected to the audio device create the playback list in which audio data of a song matching a held filter condition is registered.

Meanwhile, the audio device may further comprise a final audio data holding unit which, when the portable audio player is connected, holds identification of audio data which is played back last, and, when the portable audio player is connected, if information about the playback list held in the portable audio player cannot be acquired from the portable audio player, the resume playback control unit may make the portable audio player connected to the audio device start playing back the created playback list from the identification of audio data which is held. Further, when the portable audio player is connected, if information about the playback list held in the portable audio player cannot be acquired from the portable audio player and the filter condition is not held, the resume playback control unit may make the portable audio player connected to the audio device create the playback list in which all items of audio data are registered.

Further, with the audio device, the filter condition holding unit preferably holds the filter condition in association with identification information about a portable audio player connected at an applicable point of time; and, when the portable audio player is connected, if information about the playback list held in the portable audio player cannot be acquired from the portable audio player, the resume playback control unit preferably makes the portable audio player connected to the audio device create the playback list in which audio data of a song matching a filter condition held in association with identification information about a portable audio player connected at the point of time is registered.

Further, in this case, the audio device may further have a final audio data holding unit which, when the portable audio player is connected, holds identification of audio data which was played back last, in association with identification information about a portable audio player connected at an applicable point of time, and, when the portable audio player is connected, if information about the playback list held in the portable audio player cannot be acquired from the portable audio player, the resume playback control unit may make the portable audio player connected to the audio device start playing back the created playback list from audio data held in association with identification information about a portable audio player connected at the point of time. Further, in this case, when the portable audio player is connected, if information about the playback list held in the portable audio player cannot be acquired from the portable audio player and the filter condition associated with identification information about a portable audio player connected at the point of time is not held, the resume playback control unit may make the portable audio player connected to the audio device create the playback list in which all items of audio data are registered.

In addition, with the above audio device, an attribute of the song may be a genre of music of a song, an artist of a song, an album including a song or a playlist including a song.

According to this audio device, when the portable audio player is connected to the audio device, if the audio device can acquire information about a playback list from the portable audio player, it is possible to resume playing back the playback list held in the portable audio player. Consequently, in this case, it is possible to perform the same resume playback as resume playback performed by the portable audio player alone even in a state where the portable audio player is connected to the audio device.

By contrast with this, when the audio device cannot acquire information about the playback list from the portable audio player, the audio device can make the portable audio player create a playback list having the same registered audio files or equivalent attributes of songs of the registered audio files as the playback list which was played back when the portable audio player was connected to the audio device last time, using the held filter condition, and start playing back the playback list. Consequently, even when information about a playback list is not provided from the portable audio player, it is possible to perform pseudo resume playback.

Consequently, the present invention can perform resume playback of a connected portable audio player, in an audio device according to the same mode as resume playback performed by the portable audio player alone as much as possible.

In addition, the invention of the above audio device is applicable likewise to a video device with which a portable video player can be connected. That is, in this case, audio of the above audio device may be replaced with video.

As described above, the present invention can perform resume playback of a connected portable audio player, in an audio device with which a portable audio player is connected according to the same mode as resume playback performed by the portable audio player alone as much as possible.

### BRIEF DESCRIPTION OF THE DRAWINGS

FIG. 1 is a block diagram illustrating a configuration of an audio device and a portable audio player according to an embodiment of the present invention;

FIG. 2 is an illustration of song management data, playlist management data and a current playback list according to an embodiment of the present invention;

FIG. 3 is an illustration of a hierarchical structure managed by a playback control unit of a portable audio player according to an embodiment of the present invention;

FIG. 4 is an illustration of a transition of a menu according to an embodiment of the present invention;

FIG. 5 is a flowchart illustrating resume playback information registration processing according to an embodiment of the present invention; and

FIG. 6 is a flowchart illustrating resume playback control processing according to an embodiment of the present invention.

### DETAILED DESCRIPTION

Hereinafter, an embodiment of the present invention will be described.

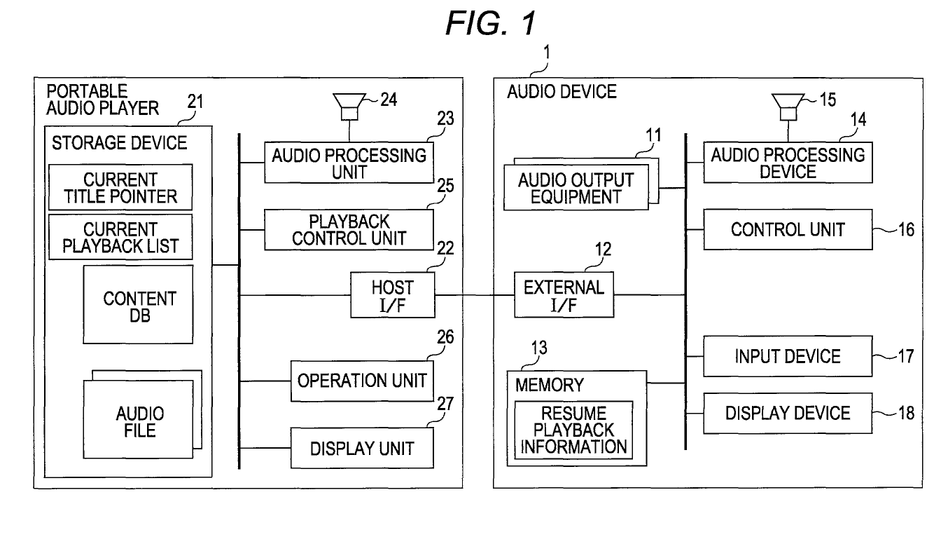

FIG. 1 illustrates a configuration of an audio device and a portable audio player according to the present embodiment.

An audio device 1 is mounted in, for example, a car and, as illustrated in FIG. 1, has an audio output equipment 11 such as a radio tuner or CD/DVD player which outputs audio data, an external interface 12, a non-volatile memory 13, an audio processing device 14, a speaker 15, a control unit 16, an input device 17 and a display device 18.

The memory 13 stores resume playback information. Further, the external interface 12 is an interface such as Bluetooth (registered trademark) which performs wireless communication or USB which performs wired communication, and a portable audio player 2 can be connected with this external interface 12.

Next, the portable audio player 2 is a portable device, and has a storage device 21, a host interface 22, an audio processing unit 23, a speaker 24, a playback control unit 25, an operation unit 26, and a display unit 27.

Meanwhile, the storage device 21 stores audio files in which audio data representing songs is stored, a content database, a current playback list and a current title pointer. Further, the host interface 22 is an interface such as Bluetooth (registered trademark) which performs wireless communication or USB which performs wired communication, and the audio device 1 can be connected with this host interface 22.

Meanwhile, the above audio device 1 or portable audio player 2 hardware may be configured as a computer having a general configuration including a microprocessor, memory and other peripheral devices, and, in this case, the control unit 16 and audio processing device 14 of the above audio device 1, and the playback control unit 25 and audio processing unit 23 of the portable audio player 2, may be realized as processes embodied by executing a program prepared in advance by the microprocessor.

Next, the content database stored in the storage device 21 of the portable audio player 2 will be described.

The content database includes song management data and playlist management data.

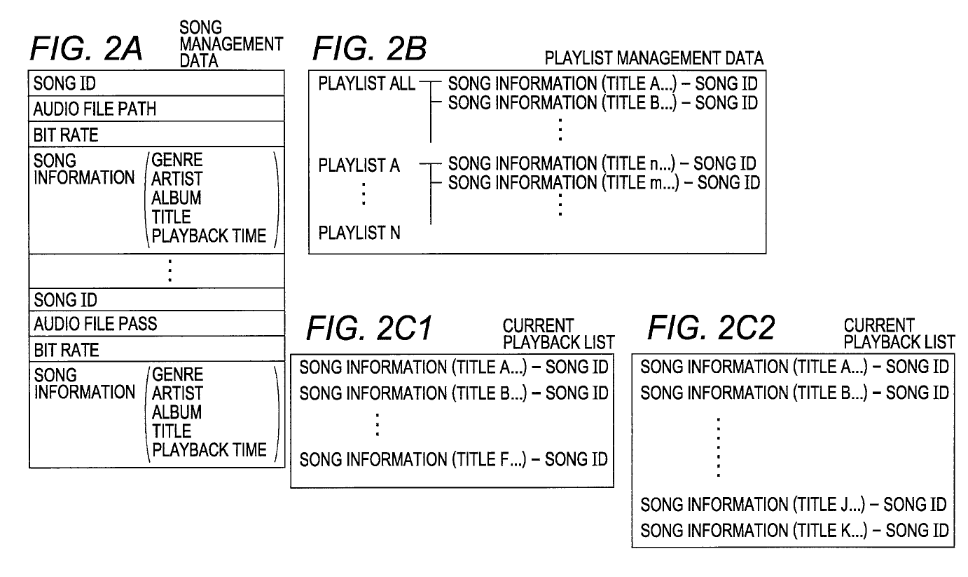

The song management data is data for managing all audio files recorded in the storage device 21 and, as illustrated in FIG. 2a, has an entry per audio file, and, in each entry, a song ID which is an identifier given to an audio file, an audio file path which indicates a location of the audio file on the storage device 21, a bit rate of audio data stored in the audio file and song information about a genre, artist, album, title and playback time of a song represented by audio data stored in the audio file are recorded.

Next, in playlist management data, an identifier (playlist All) of a default playlist which is recorded in the storage device 21 and in which all audio files are registered and an identifier of a playlist in which the user selects and registers a random audio file are registered as illustrated in FIG. 2b, and, for the identifier of each playlist, song information about, for example, a title of a song of each audio file registered in the playlist with the identifier and a song ID of each audio file are registered in a registration order of audio files.

Next, the current playback list and current title pointer recorded in the storage device 21 of the portable audio player 2 will be described.

The current playback list is a list of audio files which are currently playback targets, and, as illustrated in FIG. 2c1, song information about, for example, a title of a song of each audio file and song ID of each audio file are registered in the registration order.

Next, the current title pointer indicates identification of audio files which are currently playback targets among audio files registered in the current playback list, in the order of the audio file in the current playback list.

Further, based on the content database including these song management data and playlist management data, the playback control unit 25 of the portable audio player 2 manages a genre specific hierarchical structure, an artist specific hierarchical structure, an album specific hierarchical structure, a title specific hierarchical structure and a playlist specific hierarchical structure of each audio file.

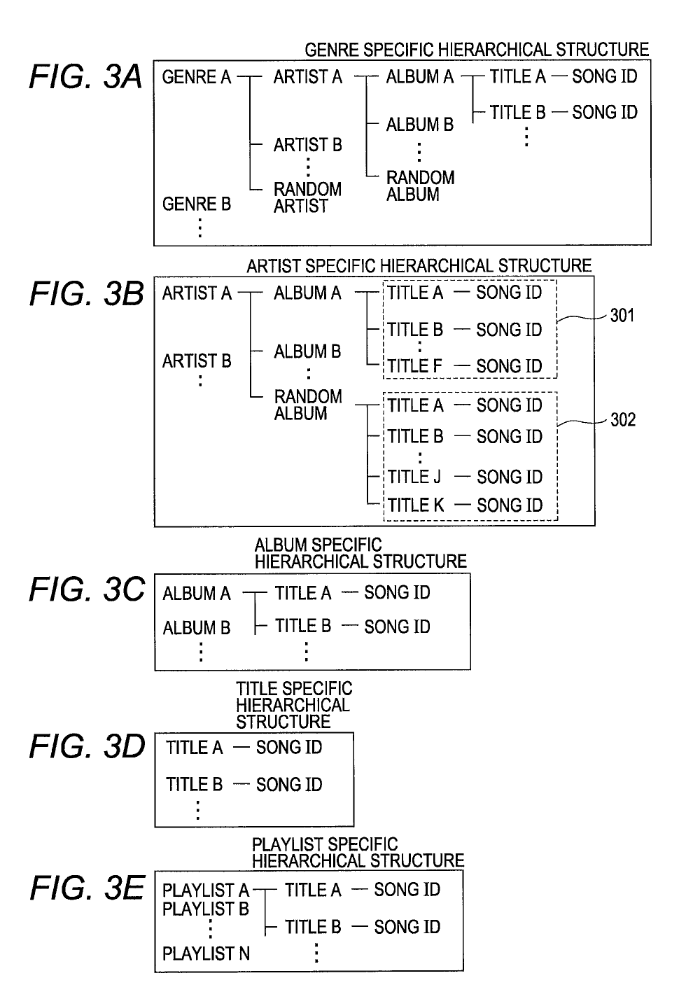

As illustrated in FIG. 3a, in the uppermost layer of the genre specific hierarchical structure, each genre of a song such as POP, ROCK and JAZZ is positioned in an alphabetical order. Further, in the subclass of each genre, an artist of a song of this genre for which an audio file of the song is recorded in the storage device 21 is positioned in an alphabetical order. Further, in the subclass of each artist, each album including songs of this artist of this genre for which audio files of the songs are recorded in the storage device 21 is positioned in an alphabetical order. Further, in the subclass of each genre, a random artist is also positioned, and, in the subclass of a random artist, each album including songs of a random artist of this genre for which audio files of the songs are recorded in the storage device 21 is positioned in an alphabetical order.

Further, in the subclass of each album, a title of a song of this album of this artist (a random artist in case of a random artist) of this genre for which an audio file of the song is recorded in the storage device 21, and a song ID of the audio file of this song are positioned in an order matching the order of the song in the album. Further, in the subclass of each artist (including a random artist), a random album is also positioned, and, in the subclass of the random album, a title of a song of this artist (a random artist in case of a random artist) of this genre for which an audio file of the song is recorded in the storage device 21, and a song ID of the audio file of this song are positioned in an alphabetical order.

Next, as illustrated in FIG. 3b, in the uppermost layer of the artist specific hierarchical structure, each artist for which an audio file of a song is recorded in the storage device 21 is positioned in an alphabetical order. Further, in the subclass of each artist, each album including songs of this artist for which audio files of the songs are recorded in the storage device 21 is positioned in an alphabetical order.

Further, in the subclass of each album, titles of songs of this album of this artist for which audio files of the songs are recorded in the storage device 21, and song IDs of the audio files of the songs are positioned in the order matching the order of songs in the album. Further, in the subclass of each artist, a random album is also positioned, and, in the subclass of the random album, titles of songs of this artist for which audio files of the songs are recorded in the storage device 21, and song IDs of the audio files of the songs are positioned in an alphabetical order.

Next, as illustrated in FIG. 3c, in the uppermost layer of the album specific hierarchical structure, each album including songs for which audio files of the songs are recorded in the storage device 21 is positioned in an alphabetical order.

Further, in the subclass of each album, titles of songs of this album for which audio files of the songs are recorded in the storage device 21 and song IDs of the audio files of the songs are positioned in the order matching the order of the songs in the album.

Further, as illustrated in FIG. 3d, in the title specific hierarchical structure, the title of each song for which an audio file of each song is recorded in the storage device 21 and a song ID of the audio file of this song are positioned in an alphabetical order.

Further, as illustrated in FIG. 3e, in the uppermost layer of the playlist specific hierarchical structure, each playlist which is registered in playlist management data except the default playlist All is positioned in an alphabetical order, and, in the subclass of each playlist, titles of songs of audio files registered in the playlist and song IDs of the audio files of the songs are positioned in the order matching the registration order of the song IDs in the playlist in playlist management data.

Referring back to FIG. 1, the audio processing unit 23 of the audio device 1 has a function of outputting audio sound represented by audio data input from an audio source, to the speaker 15 after the audio sound is decoded, if necessary. By contrast with this, the control unit 16 of the audio device 1 performs processing of setting one of the audio output equipment 11 and portable audio player 2 as an audio source according to a user's operation of the operation unit 26. Further, when the audio output equipment 11 is set as the audio source, while controlling the operation of the audio output equipment 11 according to the user's operation of the operation unit 26, the control unit 16 controls the audio processing unit 23 to perform processing of outputting audio sound represented by audio data output from the audio output equipment 11, to the speaker 15.

By contrast with this, the playback control unit 25 of the portable audio player 2 creates a current playback list to store in the storage device 21. Further, the playback control unit 25 of the portable audio player 2 plays back the current playback list, and performs an operation of outputting the audio sound which is played back, to the speaker 24 through the audio processing unit 23 when the portable audio player 2 is not connected to the audio device 1, and outputting the audio sound which is played back, to the audio device 1 when the portable audio player 2 is connected to the audio device 1.

Meanwhile, to play back the current playback list, an audio file is played back which is indicated by an audio file path registered in an entry in which a song ID of song management data registered in the current playback list is registered.

Further, the current playback list is created as follows.

That is, when the portable audio player 2 is not connected to the audio device 1, the playback control unit 25 of the portable audio player 2 displays an appropriate menu on the display unit 27 and receives a user's specification of a playlist or at least one condition of a genre, artist, album or title of a song. Further, when specification of the playlist is received, a current playback list is created for which song information and a song ID are registered in association with an identifier of the specified playlist in playlist management data. By contrast with this, when specification of a condition such as a genre, artist or album of a song is received, a song ID of an audio file of a song satisfying the condition is searched for according to each hierarchical structure illustrated in FIG. 3 to create a current playback list for which the searched song ID and song information registered in an entry in which the searched song ID of song management data is registered are registered. Further, when playback of all audio files is commanded, song information and song IDs of “playlist All” in playlist management data are registered as is to create a current playback list.

Further, when the portable audio player 2 is connected, the current playback list is created as follows.

First, the control unit 16 of the audio device 1 displays a route menu having menu items such as “album”, “genre”, “artist”, “playlist” and “songs” in response to a user search menu invocation operation using the input device 17, and receives a user's selection of the menu item.

Further, when “album” is selected in the route menu, the control unit 16 of the audio device 1 operates in collaboration with the playback control unit 25 of the portable audio player 2 to sequentially display a menu for hierarchically receiving the specification of the album and title on the display device 18 of the audio device 1 according to the above album specific hierarchical structure, and receives a user's specification of the album and title.

Further, similarly, when “genre” is selected in the route menu, the control unit 16 of the audio device 1 operates in collaboration with the playback control unit 25 of the portable audio player 2 to sequentially display a menu for hierarchically receiving the specification of the genre, artist, album and title, on the display device 18 of the audio device 1 according to the above genre specific hierarchical structure, and receives a user's specification of the genre, artist, album and title.

Further, similarly, when “artist” is selected in the route menu, the control unit 16 of the audio device 1 operates in collaboration with the playback control unit 25 of the portable audio player 2 to sequentially display a menu for hierarchically receiving the specification of the artist, album and title, on the display device 18 of the audio device 1 according to the above artist specific hierarchical structure, and receives a user's specification of the artist, album and title.

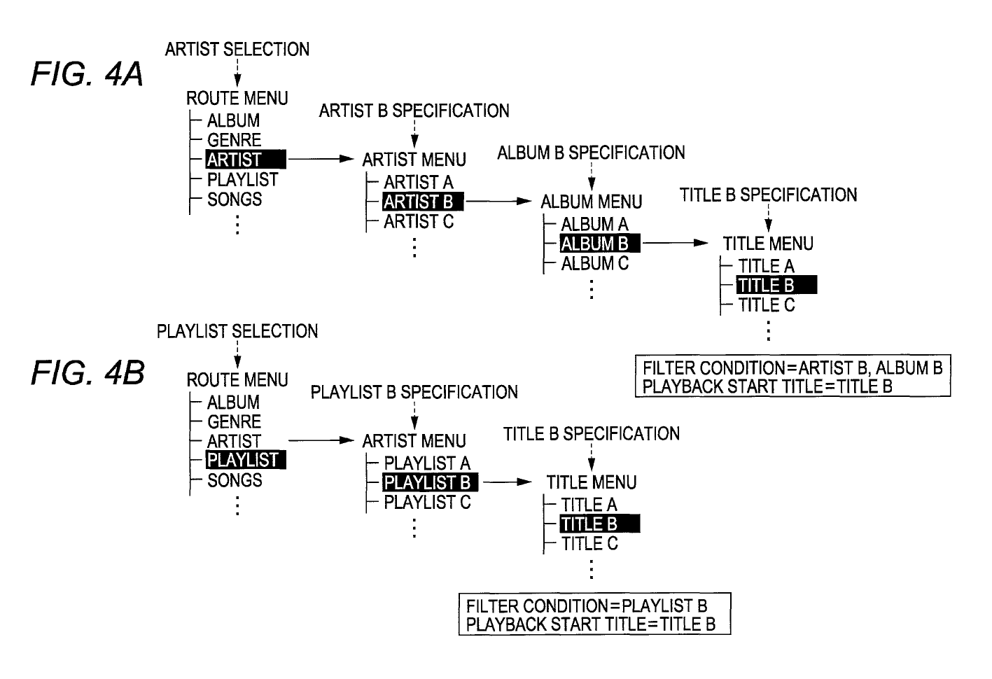

FIG. 4a illustrates a transition of a menu when “artist” is selected in the route menu in this way and, as illustrated in FIG. 4a, when “artist” is selected in the route menu, a menu transitions to an artist menu which displays a list of artists positioned in the uppermost rank of the artist structure in the same arrangement order of artists as the arrangement order in the artist specific hierarchical structure. When “artist B” is specified on the artist menu, a menu transitions to an album menu which displays a list of albums positioned in a lower rank of “artist B” in the artist specific hierarchical structure in the same arrangement order of albums as the arrangement order in the artist specific hierarchical structure. Further, when “album B” is specified on the album menu, a menu transitions to a title menu which displays a list of titles positioned in a lower rank of “album B” in the artist specific hierarchical structure in the same arrangement order of titles as the arrangement order of the titles in the artist specific hierarchical structure, and receives the specification of a title on the title menu.

Further, similarly, when “playlist” is selected in the route menu, the control unit 16 of the audio device 1 operates in collaboration with the playback control unit 25 of the portable audio player 2 to sequentially display a menu for hierarchically receiving the specification of the playlist and title, on the display device 18 of the audio device 1 according to the above playlist specific hierarchical structure, and receives a user's specification of the playlist and title.

FIG. 4b illustrates a transition of a menu when “playlist” is selected in the route menu in this way and, as illustrated in FIG. 4b, when “playlist” is selected in the route menu, a menu transitions to a playlist menu which displays a list of playlists positioned in the uppermost rank of the playlist specific hierarchical structure in the same arrangement order of playlists as the arrangement order in the playlist specific hierarchical structure. Further, when specification of “playlist B” is received on the playlist menu, a menu transitions to a title menu which displays a list of titles positioned in a lower rank of “playlist B” in the playlist specific hierarchical structure in the same arrangement order of titles as the arrangement order in the playlist specific hierarchical structure, and receives the specification of a title on the title menu.

Further, similarly, when “songs” is selected in the route menu, the control unit 16 of the audio device 1 operates in collaboration with the playback control unit 25 of the portable audio player 2 to display a menu for receiving the specification of the title, on the display device 18 of the audio device 1 according to the above title specific hierarchical structure, and receives a user's specification of the title. Further, when receiving a user's specification of the title using the above menu, the control unit 16 of the audio device 1 requests the playback control unit 25 of the portable audio player 2 to create a current playback list for which a filter condition is specified using the title specified by the user as a playback start title under the filter condition of a combination of the genre, artist, album and playlist specified by the user so far, and start playing back the playback start title of the playback list. Further, the control unit 16 of the audio device 1 uses a list of titles in a title menu for which the playback start title is specified, as current playback list information showing information about the current playback list to present to the user song information and a playback order of each audio file which is the playback target, and receive a switch operation of the audio file to be played back. Meanwhile, current playback list information corresponds to information in which the song IDs are removed from the current playback list.

By contrast with this, the playback control unit 25 of the portable audio player 2 which receives a request to create the playback list searches for a song ID of an audio file of a song matching the specified filter condition, using each hierarchical structure illustrated in FIG. 3, and creates a current playback list in which the searched song ID and song information registered in an entry in which the searched song ID of song management data is registered are registered. Further, the playback control unit 25 of the portable audio player 2 which receives a request to start playing back the playback start title of the playback list starts playing back the audio file of the song of the playback start title of the current playback list. In addition, the filter condition when “songs” is selected in the route menu is “all audio files”, that is, no filter.

That is, when, for example, “artist” is selected in the route menu in FIG. 4a, “artist B” is specified in the artist menu and “title B” is specified in the title menu, the control unit 16 of the audio device 1 requests the playback control unit 25 of the portable audio player 2 to create a current playback list under the filter condition of “artist B and album B” using “title B” as the playback start title, and starts playing back the audio file of the playback start title of the created current playback list.

Further, when, for example, “playlist” is selected in the route menu in FIG. 4b, “playlist B” is specified in the artist menu, and “title B” is specified in the title menu, the control unit 16 of the audio device 1 requests the playback control unit 25 of the portable audio player 2 to create a current playback list under the filter condition of “playlist B” using “title B” as the playback start title, and start playing back the audio file of the playback start title of the created current playback list.

By contrast with this, when, for example, “artist A and album A” are specified as the filter condition, the playback control unit 25 of the portable audio player 2 creates a current playback list in which each song ID included in a portion 301 positioned in a lower rank of the album A in the lower rank of the artist A in the artist specific hierarchical structure in FIG. 3b, and song information registered in an entry of song management data in which each song ID is registered are registered as illustrated in FIG. 2c1, and starts playing back the created current playback list from the audio file of the song of the specified playback start title.

Further, similarly, when, for example, “artist A and random album” are specified as the filter condition, the playback control unit 25 of the portable audio player 2 creates the current playback list in which each song ID included in a portion 302 positioned in a lower rank of the random album in the lower rank of the artist A in the artist specific hierarchical structure in FIG. 3b, and song information registered in the entry of song management data in which each song ID is registered are registered as illustrated in FIG. 2c2, and starts playing back the created current playback list from the audio file of the song of the specified playback start title.

Further, when “playlist A” is specified as the filter condition, the playback control unit 25 creates the current playback list in which each song ID positioned in a lower rank of “playlist A” in the playlist specific hierarchical structure in FIG. 3e, and song information registered in the entry in which each song ID is registered are registered, and starts playing back the created current playback list from the audio file of the song of the specified playback start title. Meanwhile, the current playback list in this case can be created by registering the song information and song ID of “playlist A” of playlist management data as is.

Next, when “all audio files” is specified as the filter condition, the current playback list is created by registering the “playlist All” song information and song ID of playlist management data as is.

The control unit 16 of the audio device 1 acquires a list showing a list of genres, artists, albums, playlists or titles in each menu, from the playback control unit 25 of the portable audio player 2, and generates the list. Further, the playback control unit 25 of the portable audio player 2 creates this list such that the arrangement order of the genres, artists, albums, playlists or titles in this list matches with the arrangement order of the portion matching this list in each hierarchical structure in FIG. 3. Consequently, it is possible to identify the genre, artist, album, playlist or title according to the order in the list between the control unit 16 of the audio device 1 and playback control unit 25 of the portable audio player 2. Hence, it may be possible to notify identification of the genre, artist, album, playlist or title according to the order in the list between the control unit 16 of the audio device 1 and playback control unit 25 of the portable audio player 2.

For example, for the identification of the genre, artist, album or playlist in the above filter condition, the order of the genre, artist or album playlist in the list may be used.

That is, in this case, when “artist N and album M” are specified as the filter condition, if the order of “artist N” in the list which represents a list of artists in the artist menu in which “artist N” is specified and which is acquired from the playback control unit 25 of the portable audio player 2 is nₜₕ, and the order of “album M” in the list which represents a list of albums in the album menu in which this “album M” is specified and which is acquired from the playback control unit 25 of the portable audio player 2 is mₜₕ, (artist order=n and album order=m) is used as the filter condition.

Further, similarly, for identification of the playback start title, the order of the title which is the playback start title in the list may be used.

That is, in this case, when “artist N and album M” are specified as the filter condition and the playback start title is “title K”, the order of “title K” in the list which represents a list of titles in the title menu in which this “title K” is specified and which is acquired from the playback control unit 25 of the portable audio player 2 is kₜₕ, (title order=k) may be used to identify the playback start title.

Further, with this configuration, the control unit 16 of the audio device 1 performs resume playback information registration processing and resume playback control processing to perform resume playback of the portable audio player 2.

First, resume playback information registration processing will be described.

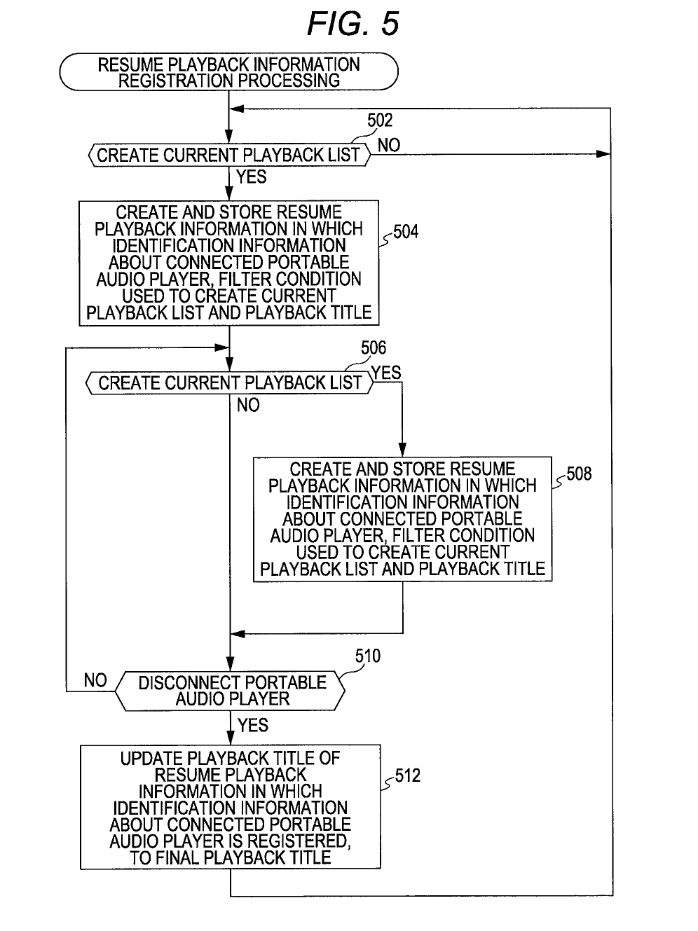

As illustrated in FIG. 5, according to resume playback information registration processing, whether or not the current playback list of the portable audio player 2 connected to the audio device 1 is created by the control unit 16 of the audio device 1 is monitored (step 502).

Further, when the current playback list is created, identification information about the connected portable audio player 2, the filter condition used to create the created current playback list, and resume playback information in which the playback title is registered are created and stored in the memory 13 (step 504). Meanwhile, in step 504, identification of the title used as the playback title to command to start playing back the current playback list is registered in resume playback information. In addition, for identification of the title to be registered as the playback title, the order of this title in the current playback list information, that is, the order of this title in the current playback list, may be registered.

Subsequently, whether or not the current playback list is created (step 506) and the portable audio player 2 and audio device 1 are disconnected (step 510) is monitored.

Further, when the current playback list is created (step 506), similar to step 504, the filter condition used to create the created current playback list and resume playback information in which the playback title is registered are created and stored in the memory 13 (step 508). Meanwhile, in step 508, identification of the title used as the playback title to command to start playing back the current playback list is registered in resume playback information. Further, when resume playback information created in step 508 is stored, if resume playback information in which identification information about the connected portable audio player 2 is registered is already stored in the memory 13, the resume playback information which is already stored is discarded, and then the created resume playback information is stored in the memory 13.

Then, the step returns to monitoring in steps 506 and 510.

By contrast with this, when the portable audio player 2 and audio device 1 are disconnected (step 510), the playback title of resume playback information in which identification information about the portable audio player 2 is registered is updated to identification of the title which was the last playback target before disconnection (step 512).

Then, the step returns to monitoring in step 502.

The resume playback information registration processing has been described.

In addition, with the above resume playback information registration processing, step 512 may be skipped and, instead, processing may be added which updates the playback title of resume playback information in which identification information about the portable audio player 2 is registered to represent identification of the title of the playback target when a title of the playback target is switched.

Next, resume playback control processing will be described.

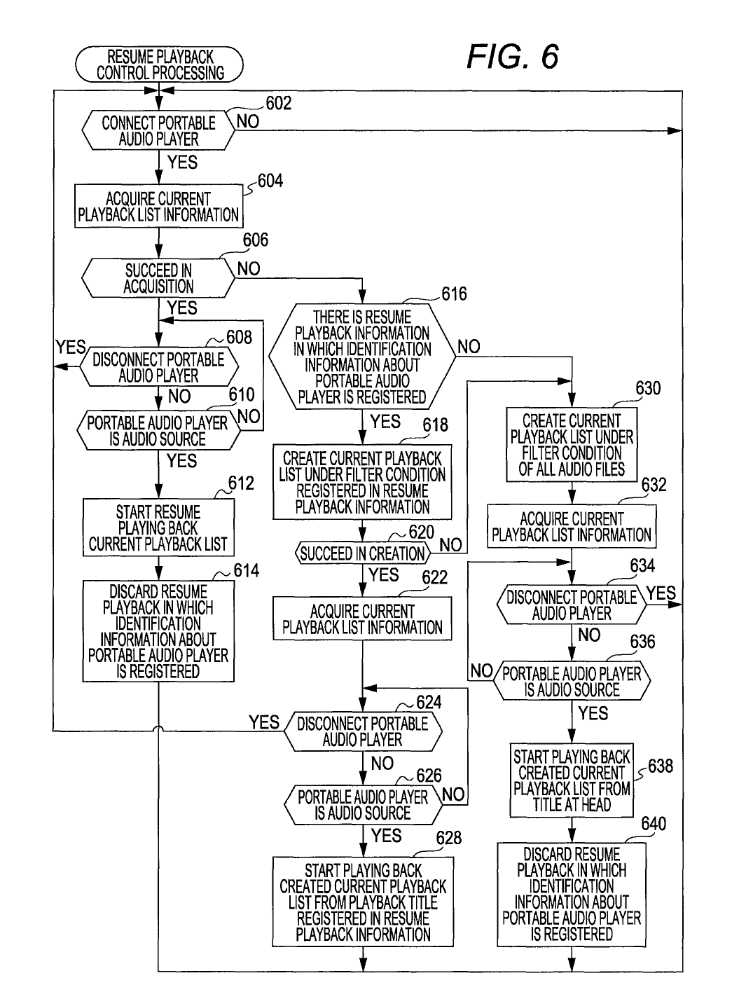

As illustrated in FIG. 6, with resume playback control processing, whether or not the portable audio player 2 and audio device 1 are connected is monitored (step 602), and, when the portable audio player 2 is connected, acquisition of current playback list information from the portable audio player 2 is tried (step 604).

Meanwhile, current playback list information is acquired by requesting the playback control unit 25 of the portable audio player 2 to transmit current playback list information, and receiving current playback list information transmitted from the playback control unit 25 of the portable audio player 2 in response to this request. When receiving the request to transmit current playback list information, from the control unit 16 of the audio device 1, the playback control unit 25 of the portable audio player 2 transmits information in which a song ID is removed from a current playback list, in response to the request as current playback list information to the control unit 16 of the audio device 1 if there is the current playback list in the storage device 21 of the portable audio player 2 and the portable audio player 2 can transmit current playback list information. By contrast with this, when there is no current playback list in the storage device 21 of the portable audio player 2, or when the portable audio player 2 cannot transmit current playback list information while there is the current playback list in the storage device 21 of the portable audio player 2, the playback control unit 25 of the portable audio player 2 transmits an error to the control unit 16 of the audio device 1 in response to the request to transmit the current playback list information. In addition, an example of a case where the portable audio player 2 cannot transmit current playback list information even though there is the current playback list in the storage device 21 of the portable audio player 2 includes a state where the current playback list created before power is turned off is held in the portable audio player 2 which, after power is turned on, cannot transmit playback current list information about the current playback list created before power is turned off.

Next, whether or not the above acquisition of current playback list information from the portable audio player 2 succeeded is checked (step 606), and, if acquisition of current playback list information succeeded, whether the portable audio player 2 is disconnected from the audio device (step 608) and the portable audio player 2 is set to the above audio source (step 610) is monitored, and, when the portable audio player 2 is disconnected from the audio device, the step returns to step 602. By contrast with this, when the portable audio player 2 is set to the audio source (step 610), the portable audio player 2 is commanded to resume playing back the title indicated by the current title pointer in the current playback list (step 612), resume playback information in which identification information about the connected portable audio player 2 is registered is erased from the memory 13 (step 614), and the step returns to processing in step 602.

As a result, the portable audio player 2 starts playing back the title playback of which was stopped the last time in the current playback list held in the portable audio player 2.

By contrast with this, when acquisition of current playback list information from the portable audio player 2 does not succeed (step 606), whether or not resume playback information in which identification information about the connected portable audio player 2 is registered is stored in the memory 13 is checked (step 616), and, when resume playback information is not stored, the step proceeds to step 630.

By contrast with this, when resume playback information in which identification information about the connected portable audio player 2 is registered is stored in the memory 13 (step 616), a current playback list is created under the filter condition registered in stored resume playback information (step 618) and, if creation of the current playback list succeeds (step 620), current playback list information about the current playback list created from the portable audio player 2 is acquired (step 622). Meanwhile, in step 618, the number of audio files satisfying the filter condition is first inquired to the portable audio player 2 and acquired, and, when the number of acquired audio files is not zero, creation of the current playback list under the filter condition is requested to the playback control unit 25 of the portable audio player 2 and, when the number of acquired audio files is zero, creation of the current playback list fails.

Further, whether or not the portable audio player 2 is disconnected from the audio device (step 624) and the portable audio player 2 is set to the above audio source (step 626) is monitored, and, when the portable audio player 2 is disconnected from the audio device, the step returns to step 602. By contrast with this, when the portable audio player 2 is set to the audio source (step 626), the playback control unit 25 of the portable audio player 2 is requested to start playing back the audio file of the playback start title using as the playback start title the title registered as the playback title in resume playback information in which identification information about the connected portable audio player 2 is registered (step 628).

As a result, the portable audio player 2 creates a current playback list having the same registered audio files or equivalent attributes such as a genre of songs of the registered audio files, artist, album to which the songs belong and playlist to which the songs belong as the current playback list which was played back last when the portable audio player 2 was connected to the audio device 1 the last time, and playback of the created current playback list is started from the title which was played back last when the portable audio player 2 was connected the last time.

Then, the step returns to processing in step 602.

By contrast with this, when creation of the current playback list fails (step 620), the step proceeds to step 630.

Further, when the step proceeds from step 616 or step 620 to step 630 as described above, the playback control unit 25 of the portable audio player 2 is requested to create the current playback list under the filter condition of “all audio files” (step 630), and acquire current playback list information about the current playback list created from the portable audio player 2 (step 632). Further, whether or not the portable audio player 2 is disconnected from the audio device (step 634) and the portable audio player 2 is set to the above audio source (step 636) is monitored, and, when the portable audio player 2 is disconnected from the audio device, the step returns to step 602. By contrast with this, when the portable audio player 2 is set to the audio source (step 636), the playback control unit 25 of the portable audio player 2 is requested to start playing back the audio file of the playback start title using as the playback start title the title at the head of the current playback list (step 638).

As a result, the portable audio player 2 creates the current playback list in which all audio files stored in the portable audio player 2 are registered, and starts playing back the title at the head of the created current playback list .

Further, resume playback information in which identification information about the connected portable audio player 2 is registered is erased from the memory 13 (step 640), and the step returns to processing from step 602.

The resume playback control processing has been described above.

In addition, current playback list information acquired from the portable audio player 2 by the above resume playback control processing, is used by the control unit 16 of the audio device 1 to present to the user song information or a playback order of each audio file which is the playback target and receive a switching operation of the audio file to be played back.

According to the above resume playback information registration processing and resume playback control processing, when the portable audio player 2 is connected to the audio device 1, if the audio device 1 can acquire current playback list information about a current playback list from the portable audio player 2, the audio device 1 can resume playing back the title playback of which was stopped the last time in the current playback list held in the portable audio player 2. Consequently, in this case, it is possible to perform the same resume playback as resume playback performed by the portable audio player alone even in a state where the portable audio player is connected to the audio device.

By contrast with this, when the audio device 1 cannot acquire current playback list information about the current playback list from the portable audio player 2, the audio device 1 makes the portable audio player 2 create a current playback list having the same registered audio files or equivalent attributes such as a genre of songs of the registered audio files, artist, album to which the songs belong and playlist to which the songs belong as the current playback list which was played back last when the portable audio player 2 was connected to the audio device 1 last time, using the filter condition registered in resume playback information, and start playing back the current playback list from the title which was played back last when the portable audio player 2 was connected the last time, using the playback title registered in resume playback information. Consequently, it is possible to perform pseudo resume playback even in a case where the portable audio player does not provide current playback list information.

Consequently, according to the present embodiment, the audio device 1 can perform resume playback of the connected portable audio player 2 according to the same mode as resume playback performed by the portable audio player alone as much as possible.

Although a case has been described with the above embodiment where the audio device 1 controls resume playback of the portable audio player 2, the present embodiment is applicable likewise to a case where a video device controls resume playback of a portable video player by replacing audio with video in the above description.

While there has been illustrated an described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teaching of the invention without departing from the central scope thereof. Therefore, it is intended that this invention not be limited to the particular embodiments disclosed, but that the invention will include all embodiments falling within the scope of the appended claims.

What is claimed is:

1. An audio device which can store audio data of a song and a playback list in which audio data is registered, and which can be connected with a portable audio player which plays back audio data registered in the playback list, the audio device comprising:
a playback list creating unit which makes the portable audio player connected with the audio device create a playback list in which audio data of a song matching a filter condition is registered, using a condition of an attribute of a song specified by a user as a filter condition;
a filter condition holding unit which, when the portable audio player is connected, holds the filter condition used last by the playback list creating unit to create the playback list of the portable audio player; and
a resume playback control unit which, when the portable audio player is connected, tries to acquire information about the playback list held by the portable audio player, from the portable audio player, and, when information about the playback list can be acquired, makes the portable audio player start playing back the playback list held in the portable audio player, and, when information about the playback list cannot be acquired, makes the portable audio player connected to the audio device create the playback list in which audio data of a song matching a held filter condition is registered.

2. The audio device according to claim 1, further comprising a final audio data holding unit which, when the portable audio player is connected, holds an identification of audio data which was played back last, wherein
when the portable audio player is connected, if information about the playback list held in the portable audio player cannot be acquired from the portable audio player, the resume playback control unit makes the portable audio player connected to the audio device start playing back the created playback list from audio data the identification of which is held.

3. The audio device according to claim 1, wherein
when the portable audio player is connected, if information about the playback list held in the portable audio player cannot be acquired from the portable audio player and the filter condition is not held, the resume playback control unit makes the portable audio player connected to the audio device create a playback list in which all items of audio data are registered.

4. The audio device according to claim 1, wherein
the filter condition holding unit holds the filter condition in association with identification information about a portable audio player connected at an applicable point of time; and
when the portable audio player is connected, if information about the playback list held in the portable audio player cannot be acquired from the portable audio player, the resume playback control unit makes the portable audio player connected to the audio device create the playback list in which audio data of a song matching a filter condition held in association with identification information about a portable audio player connected at the point of time is registered.

5. The audio device according to claim 4, further comprising a final audio data holding unit which, when the portable audio player is connected, holds an identification of audio data which was played back last, in association with identification information about a portable audio player connected at an applicable point of time, wherein
when the portable audio player is connected, if information about the playback list held in the portable audio player cannot be acquired from the portable audio player, the resume playback control unit makes the portable audio player connected to the audio device start playing back the created playback list from audio data held in association with identification information about a portable audio player connected at the point of time.

6. The audio device according to claim 4, wherein
when the portable audio player is connected, if information about the playback list held in the portable audio player cannot be acquired from the portable audio player and the filter condition associated with identification information about a portable audio player connected at the point of time is not held, the resume playback control unit makes the portable audio player connected to the audio device create a playback list in which all items of audio data are registered.

7. The audio device according to claim 1, wherein
an attribute of the song comprises at least one of a genre of music of a song, an artist of a song, an album including a song, and a playlist including a song.

8. A video device which can store video data and a playback list in which video data is registered, and which can be connected with a portable video player which plays back video data registered in the playback list, the video device comprising:
a playback list creating unit which makes the portable video player connected with the video device create a playback list in which video data of a song matching a filter condition is registered, using a condition of an attribute of video specified by a user as a filter condition;
a filter condition holding unit which, when the portable video player is connected, holds the filter condition used last by the playback list creating unit to create the playback list of the portable video player; and
a resume playback control unit which, when the portable video player is connected, tries to acquire information about the playback list held by the portable video player, from the portable video player, and, when information about the playback list can be acquired, makes the portable video player start playing back the playback list held in the portable video player, and, when information about the playback list cannot be acquired, makes the portable video player connected to the video device create the playback list in which video data of a song matching a held filter condition is registered.

9. A computer program which is read and executed by a computer which can store audio data of a song and a playback list in which audio data is registered, and which computer can be connected with a portable audio player which plays back audio data registered in the playback list, the computer program causing the computer to function as:
a playback list creating unit which makes the portable audio player connected with the audio device create a playback list in which audio data of a song matching a filter condition is registered, using a condition of an attribute of a song specified by a user as a filter condition;
a filter condition holding unit which, when the portable audio player is connected, holds the filter condition used last by the playback list creating unit to create the playback list of the portable audio player; and
a resume playback control unit which, when the portable audio player is connected, tries to acquire information about the playback list held by the portable audio player, from the portable audio player, and, when information about the playback list can be acquired, makes the portable audio player start playing back the playback list held in the portable audio player, and, when information about the playback list cannot be acquired, makes the portable audio player connected to the audio device create the playback list in which audio data of a song matching a held filter condition is registered.

10. The computer program according to claim 9, further causing the computer to function as a final audio data holding unit which, when the portable audio player is connected, holds an identification of audio data which was played back last, wherein
when the portable audio player is connected, if information about the playback list held in the portable audio player cannot be acquired from the portable audio player, the resume playback control unit makes the portable audio player connected to the audio device start playing back the created playback list from audio data the identification of which is held.

11. The computer program according to claim 9, wherein
when the portable audio player is connected, if information about the playback list held in the portable audio player cannot be acquired from the portable audio player and the filter condition is not held, the resume playback control unit makes the portable audio player connected to the audio device create a playback list in which all items of audio data are registered.

12. The computer program according to claim 9, wherein
the filter condition holding unit holds the filter condition in association with identification information about a portable audio player connected at an applicable point of time; and
when the portable audio player is connected, if information about the playback list held in the portable audio player cannot be acquired from the portable audio player, the resume playback control unit makes the portable audio player connected to the audio device create the playback list in which audio data of a song matching a filter condition held in association with identification information about a portable audio player connected at the point of time is registered.

13. The computer program according to claim 12, further causing the computer to function as a final audio data holding unit which, when the portable audio player is connected, holds an identification of audio data which was played back last, in association with identification information about a portable audio player connected at an applicable point of time, wherein
when the portable audio player is connected, if information about the playback list held in the portable audio player cannot be acquired from the portable audio player, the resume playback control unit makes the portable audio player connected to the audio device start playing back the created playback list from audio data held in association with identification information about a portable audio player connected at the point of time.

14. The computer program according to claim 12, wherein
when the portable audio player is connected, if information about the playback list held in the portable audio player cannot be acquired from the portable audio player and the filter condition associated with identification information about a portable audio player connected at the point of time is not held, the resume playback control unit makes the portable audio player connected to the audio device create a playback list in which all items of audio data are registered.

15. The computer program according to claim 9, wherein an attribute of the song comprises at least one of a genre of music of a song, an artist of a song, an album including a song, and a playlist including a song.

16. A computer program which is read and executed by a computer which can store video data and a playback list in which video data is registered, and which computer can be connected with a portable video player which plays back video data registered in the playback list, the computer program causing the computer to function as:
a playback list creating unit which makes the portable video player connected with the video device create a playback list in which video data of a song matching a filter condition is registered, using a condition of an attribute of video specified by a user as a filter condition;
a filter condition holding unit which, when the portable video player is connected, holds the filter condition used last by the playback list creating unit to create the playback list of the portable video player; and
a resume playback control unit which, when the portable video player is connected, tries to acquire information about the playback list held by the portable video player, from the portable video player, and, when information about the playback list can be acquired, makes the portable video player start playing back the playback list held in the portable video player, and, when information about the playback list cannot be acquired, makes the portable video player connected to the video device create the playback list in which video data of a song matching a held filter condition is registered.
